(19) United States
(12) Patent Application Publication
(10) Pub. No.: US 2017/0060520 A1
(43) Pub. Date: Mar. 2, 2017

(54) SYSTEMS AND METHODS FOR DYNAMICALLY EDITABLE SOCIAL MEDIA

(71) Applicant: AudioCommon, Inc., Chelmsford, MA (US)

(72) Inventors: Philip James Cohen, Chelmsford, MA (US); Joy Marie Johnson, Dorchester, MA (US); Maxwell Edward Bohling, Waltham, MA (US); Dale Eric Crawford, Nashville, TN (US); James Christopher Dorsey, Chelmsford, MA (US)

(21) Appl. No.: 14/918,027

(22) Filed: Oct. 20, 2015

Related U.S. Application Data
(60) Provisional application No. 62/213,018, filed on Sep. 1, 2015.

(51) Int. Cl. G06F 3/16; H04L 29/06; G05B 15/02; G10L 19/16; G06F 3/0484

(52) U.S. Cl. CPC G06F 3/165; G10L 19/167; G06F 3/04842; G05B 15/02; H04L 67/42

(57) ABSTRACT

The present disclosure describes systems and methods for providing streaming, dynamically editable social media content, such as songs, music videos, or other such content. Audio may be delivered to a computing device of a user in a multi-track format, or as separate audio files for each track. The computing device may instantiate a plurality of synchronized audio players and simultaneously playback the separate audio files. The user may individually adjust parameters for each audio player, allowing dynamic control over the media content during use.

### RELATED APPLICATIONS

The present application claims priority to and the benefit of U.S. Provisional Application No. 62/213,018, entitled “Systems and Methods for Dynamically Editable Social Media,” filed Sep. 1, 2015, the entirety of which is hereby incorporated by reference.

### FIELD

The present application relates to systems and methods for providing streaming, dynamically editable multi-track audio for social media.

### BACKGROUND

Social media applications allow users to discover and consume media, including videos and songs, as well as comment on the media and/or share the media with friends or other users of the social media application. While these systems allow users to interact with each other and with artists through comments and “likes”, the users are passive consumers of the media with no ability to modify or edit it.

### SUMMARY

The present disclosure describes systems and methods for providing streaming, dynamically editable social media content, such as songs, music videos, or other such content. Audio may be delivered to a computing device of a user in a multi-track format, or as separate audio files for each track. The computing device may instantiate a plurality of synchronized audio players and simultaneously playback the separate audio files. The user may individually adjust parameters for each audio player, allowing dynamic control over the media content during use.

In one aspect, the present application is directed to systems and methods for multi-track audio playback. In one implementation, a client device may transmit, to a server, a request for an item of media. The client device may receive, from the server, an identification of locations of each of a plurality of tracks of the item of media. The client device may instantiate or establish a plurality of playback engines corresponding to the plurality of tracks. The client device may retrieve a first portion of each of the plurality of tracks of the item of media based on the received identifications, and direct each of the retrieved first portions of each of the plurality of tracks to a corresponding one of the plurality of playback engines. Each playback engine may decode the first portion of the corresponding track of the plurality of tracks. A mixer of the client device may iteratively combine outputs of each of the plurality of playback engines to generate a combined multi-track output.

In some implementations, the client device may retrieve a second portion of each of the plurality of tracks of the item of media, during decoding of the first portion of the plurality of tracks by the plurality of playback engines. In one implementation, instantiating the plurality of playback engines includes establishing separate input and output buffers for each of the plurality of playback engines. In another implementation, each of the plurality of tracks comprise a separate stereo audio file. In still another implementation, iteratively combining outputs of each of the plurality of playback engines includes combining outputs of a first and second playback engine of the plurality of playback engines to create a first intermediate output; and combining the first intermediate output and the output of a third playback engine to create a second intermediate output.

In some implementations, the identification of locations of each of the plurality of tracks includes an identification of a location of a pre-generated mix of the plurality of tracks. The client device may instantiate an additional playback engine, and retrieve a first portion of the pre-generated mix. The client device may direct the retrieved first portion of the pre-generated mix to the additional playback engine, and the additional playback engine may decode the first portion of the pre-generated mix, while the client device retrieves the first portions of each of the plurality of tracks. In a further implementation, the plurality of playback engines may synchronize decoding with the additional playback engine according to a program clock triggered by the additional playback engine during decoding the first portion of the pre-generated mix. In a still further implementation, the client device may disable output of the additional playback engine and enable output of each of the plurality of playback engines, responsive to decoding the first portions of the plurality of tracks.

In another aspect, the present disclosure is directed to a method for dynamically editable multi-track playback by a mobile device. The method includes decoding a plurality of tracks of a multi-track item of media, by a corresponding plurality of playback engines executed by a processor of a mobile device. The method also includes iteratively combining, by a mixer of the mobile device, outputs of each of the plurality of playback engines to generate a combined multi-track output. The method further includes detecting, by the processor, a user interaction with an interface element corresponding to a first track of the plurality of tracks. The method also includes modifying, by the mixer, the output of a first playback engine corresponding to the first track, responsive to the detected user interaction; and iteratively combining, by the mixer, the modified output of the first playback engine with outputs of each of the other playback engines to generate a second combined multi-track output.

In one implementation, the method includes detecting an interaction with a toggle identifying an enable state of the first track. In another implementation, the method includes multiplying the output of the first playback engine by a volume coefficient. In a further implementation, the method includes detecting a disable track command for the first track; and the volume coefficient is equal to zero. In another further implementation, the method includes detecting an enable track command for the first track; and the volume coefficient is equal to a predetermined value. In a still further implementation, the method includes setting the predetermined value, by the mixer, according to a volume coefficient value prior to receipt of a disable track command for the first track.

In another implementation, the method includes receiving the plurality of tracks from a second device. In a further implementation, the method includes transmitting a request, by the mobile device to the second device, to generate a single file comprising the second combined multi-track output.

In still another aspect, the present disclosure is directed to a method for sharing dynamically modified multi-track media. The method includes receiving, by a server from a first device, a request for a multi-track item of media. The method further includes transmitting, by the server to the first device, an identification of locations of each of the plurality of tracks of the item of media, responsive to the request. The method also includes receiving, by the server from the first device, a request to generate a single file comprising a modified combination of the plurality of tracks, the request comprising modification parameters for each track. The method also includes retrieving, by the server, the plurality of tracks of the item of media from the identified locations. The method further includes iteratively combining each of the plurality of tracks to generate a new version of the item of media, by the server, each track modified according to the modification parameters; and associating the first device with the new version of the item of media.

In some implementations, the method includes receiving, by the server from a second device, a second request to generate the single file comprising the modified combination of the plurality of tracks. The method also includes determining, by the server, that modification parameters of the second request are identical to those of the first request; and associating the second device with the new version of the item of media, responsive to the determination. In a further implementation, the method includes transmitting the new version of the item of media generated for the first device, to the second device, responsive to receipt of the second request. In another implementation, the method includes receiving a request, by the server from the first device, to share the new version of the item of media with a second device; and associating the second device with the new version of the item of media, responsive to receipt of the request to share the new version of the item of media.

### BRIEF DESCRIPTION OF THE FIGURES

FIG. 1 is a diagram of an implementation of a system for providing dynamically editable social media;

FIG. 2A is a diagram of a relationship between a stereo mix and individual tracks;

FIG. 2B is a diagram of an implementation of a multi-track song database;

FIG. 3A is a flow chart of an implementation of a method for providing streaming multi-track audio;

FIG. 3B is a flow chart of an implementation of a method for providing dynamic editing during playback of multi-track audio;

FIGS. 4A-4T are screenshots of implementations of a multi-track social media application; and

FIG. 5 is a block diagram of an exemplary computing device useful for practicing the methods and systems described herein.

In the drawings, like reference numbers generally indicate identical, functionally similar, and/or structurally similar elements.

The patent or application file contains at least one drawing executed in color. Copies of this patent or patent application publication with color drawings will be provided by the Office upon request and payment of the necessary fee.

### DETAILED DESCRIPTION

The following description in conjunction with the above-reference drawings sets forth a variety of embodiments for exemplary purposes, which are in no way intended to limit the scope of the described methods or systems. Those having skill in the relevant art can modify the described methods and systems in various ways without departing from the broadest scope of the described methods and systems. Thus, the scope of the methods and systems described herein should not be limited by any of the exemplary embodiments and should be defined in accordance with the accompanying claims and their equivalents.

In some implementations of social media applications, when a user listens to media in a web browser or application, a single audio file (such as an MP3 file) is downloaded and played back, either natively in the browser or application or using a separate plugin or application on the client's device. While the user may passively consume the media, their interactions with it are typically limited to starting and stopping playback, adjusting a playback time (e.g. fast forwarding or rewinding, or moving to a different temporal position within the media), adjusting overall volume of the media, and, in many social media applications, comment on and/or share the media with other users of the social network. The user may not make substantive changes to the media itself, as it has already been mixed from initial multi-track recordings to the single audio file.

By contrast, the system discussed herein allows for playback of multiple audio files synchronously, which enables the user to mute tracks, solo tracks, and control the overall volume level of a track on a track-by-track basis. Additionally, in some implementations, effects can be applied at the track level as well, enabling the user to enhance or otherwise alter the sound of the track, or portions of the track. Synchronous playback of multiple audio files may be accomplished by associating multiple audio files or tracks with a particular song. For playback of the media, the associated tracks are downloaded to the client's device, and a number of audio players corresponding to the number of tracks are instantiated. Once enough of the tracks have been downloaded to ensure uninterrupted playback of all tracks, playback may be started in each audio player simultaneously. The audio players' output may be mixed together and provided to an output audio interface of the device. The user may individually enable or disable tracks, muting them and changing the overall mix. In some implementations, the user may adjust volume levels of each track, stereo panning position of each track, and/or apply other effects on a track-by-track basis (e.g. pitch change, reverb, phasing, flanging, equalization, etc.).

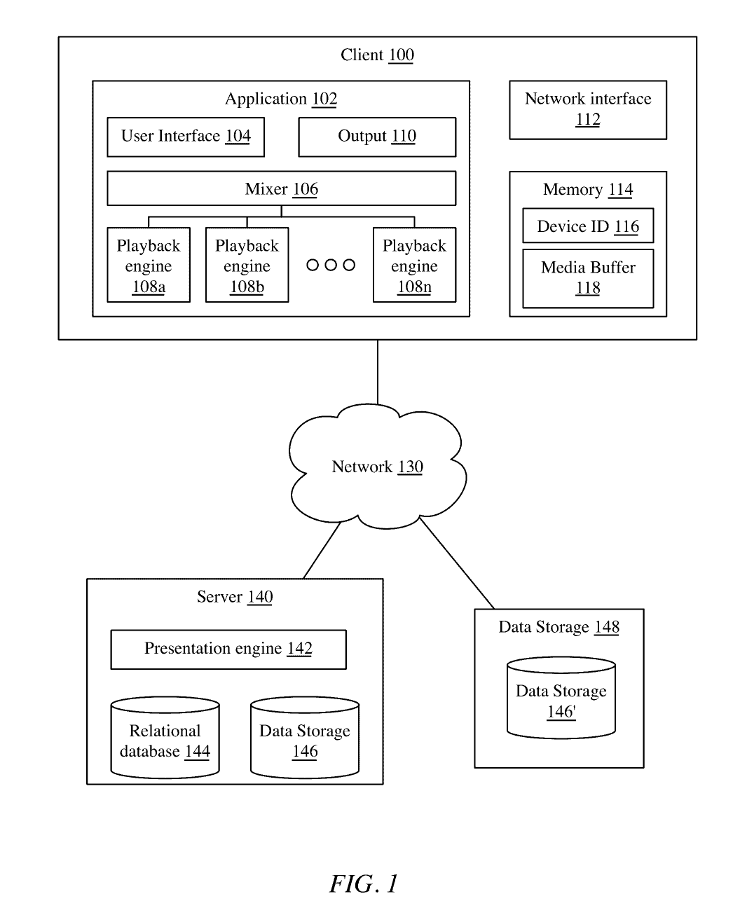

Referring first to FIG. 1, illustrated is an implementation of a system for providing dynamically editable social media. A client 100 may be a desktop computer, laptop computer, tablet computer, smart phone, wearable computer, smart television, or any other type and form of computing device. Client 100 may execute an application 102, which may be a web browser, a standalone application or applet, a service, a server, a daemon, or other executable logic for receiving and playing back multi-track media under the control of a user of the client. Application 102 may be referred to as a client application, a client agent, a user agent, or any other similar term, and may be executed by a processor of client 100 on behalf of a user.

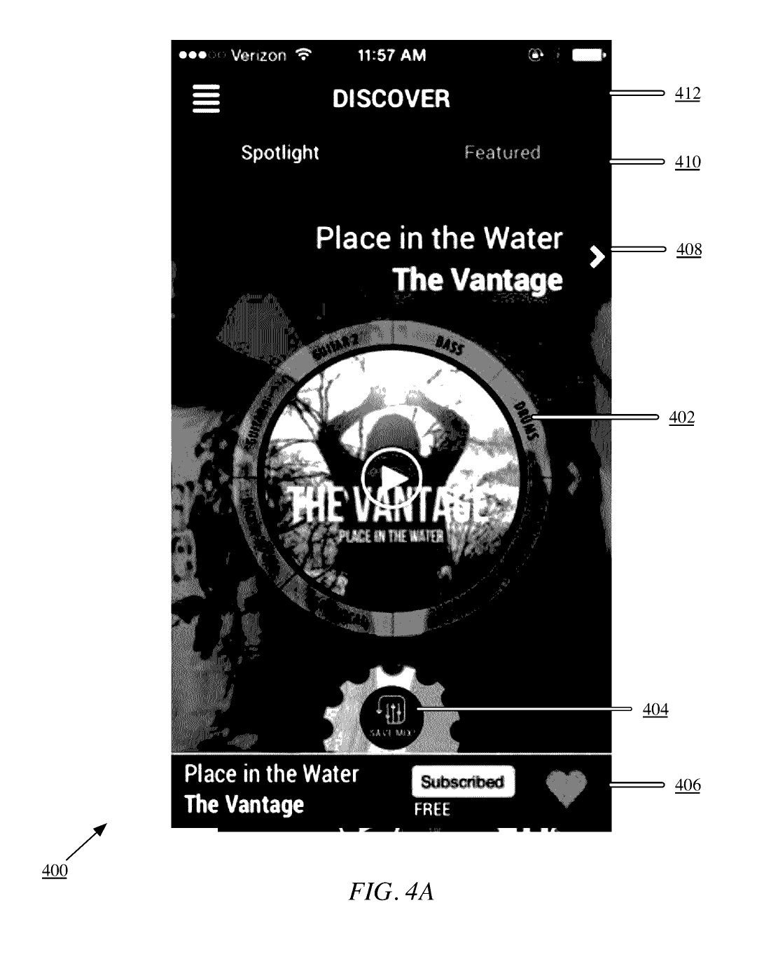

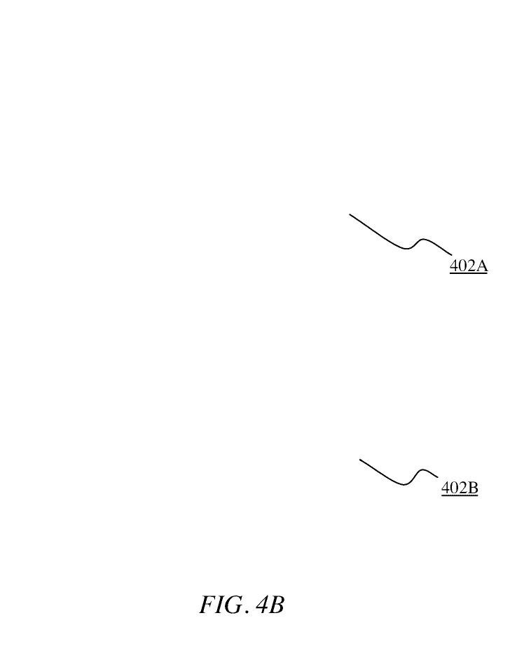

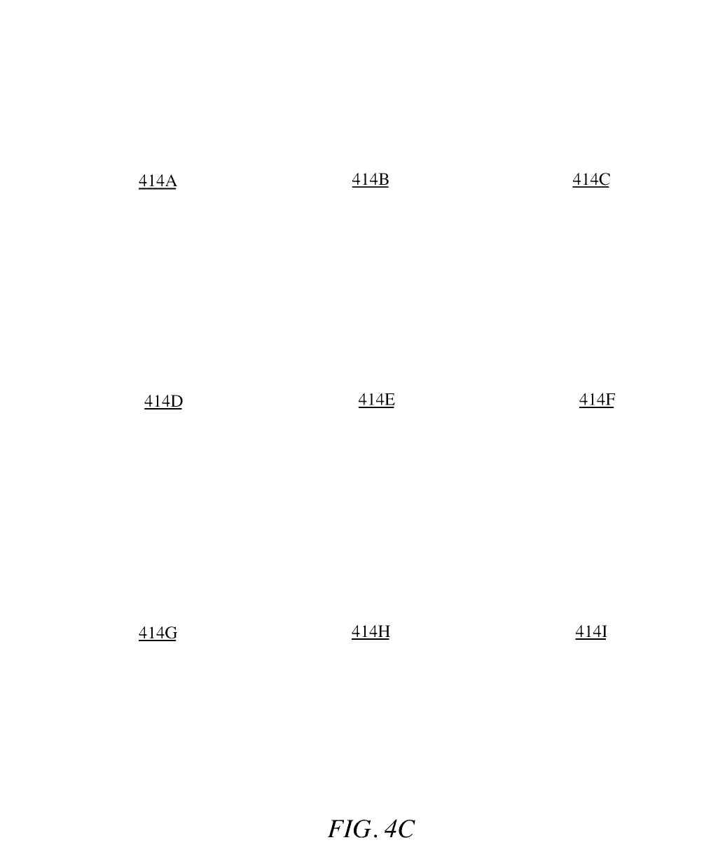

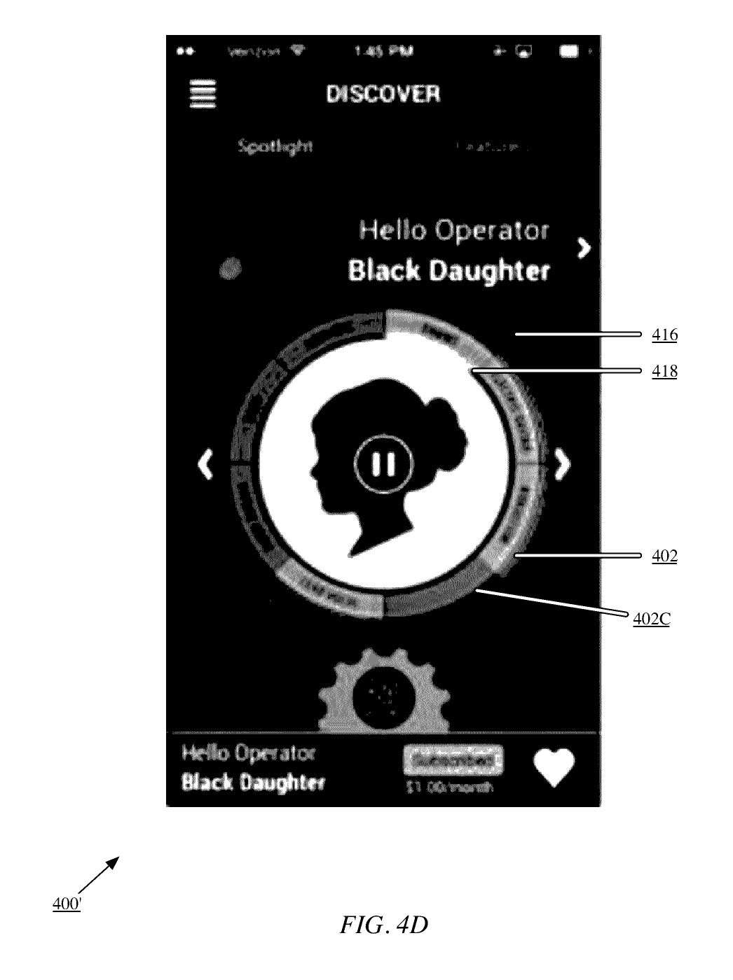

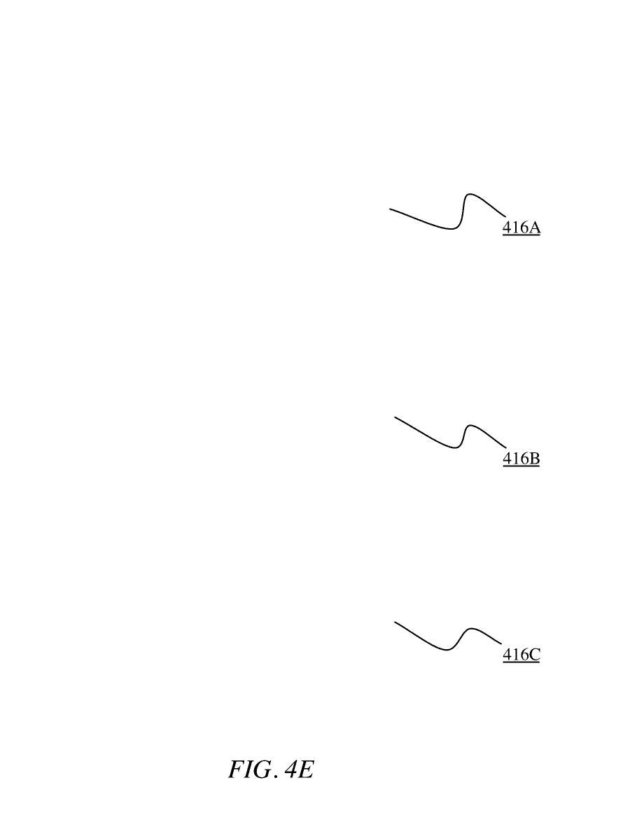

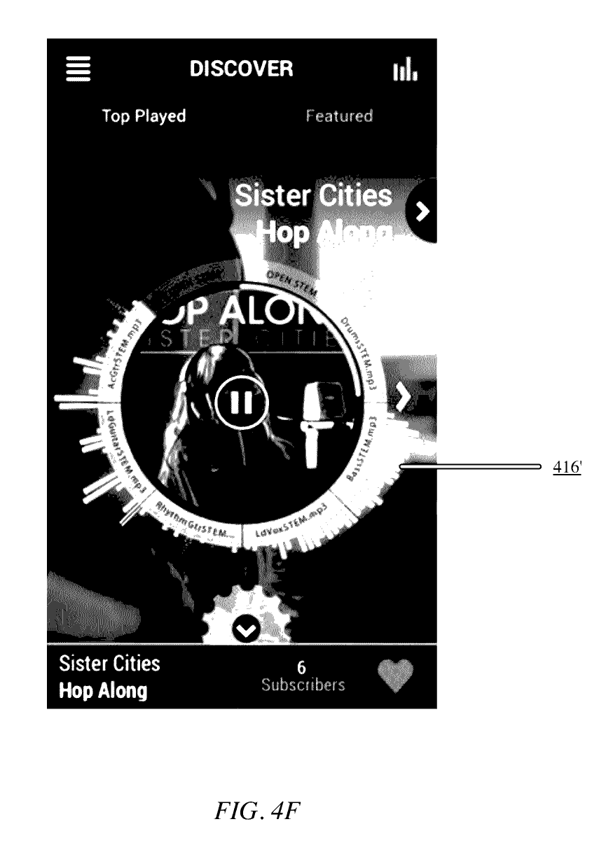

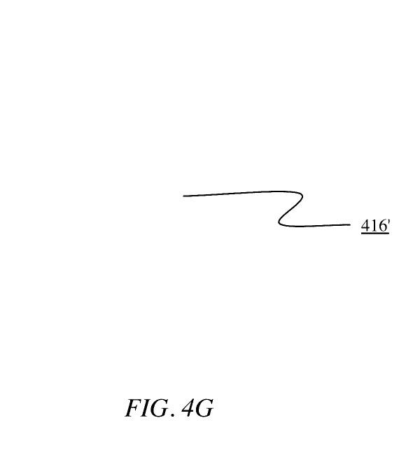

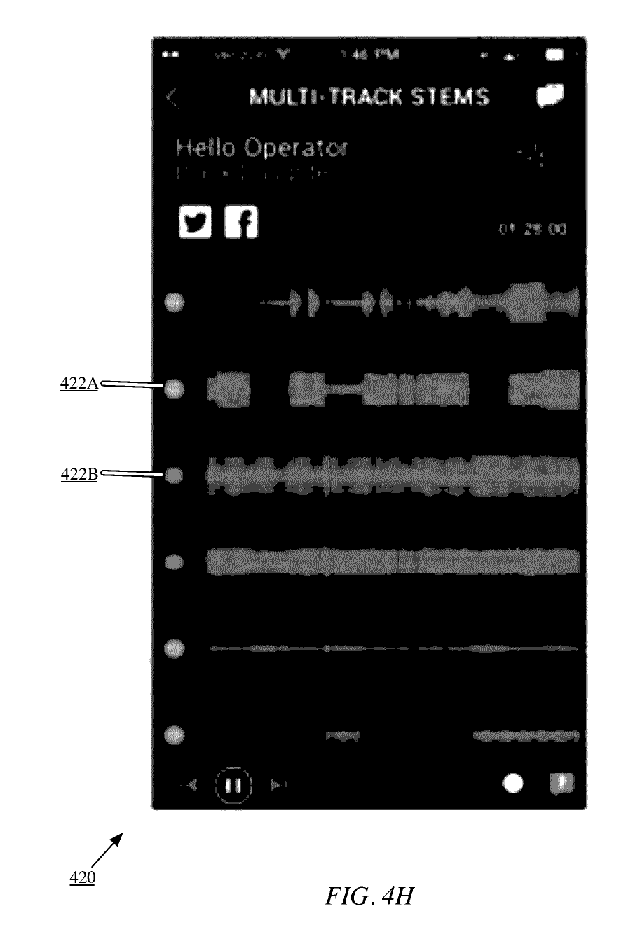

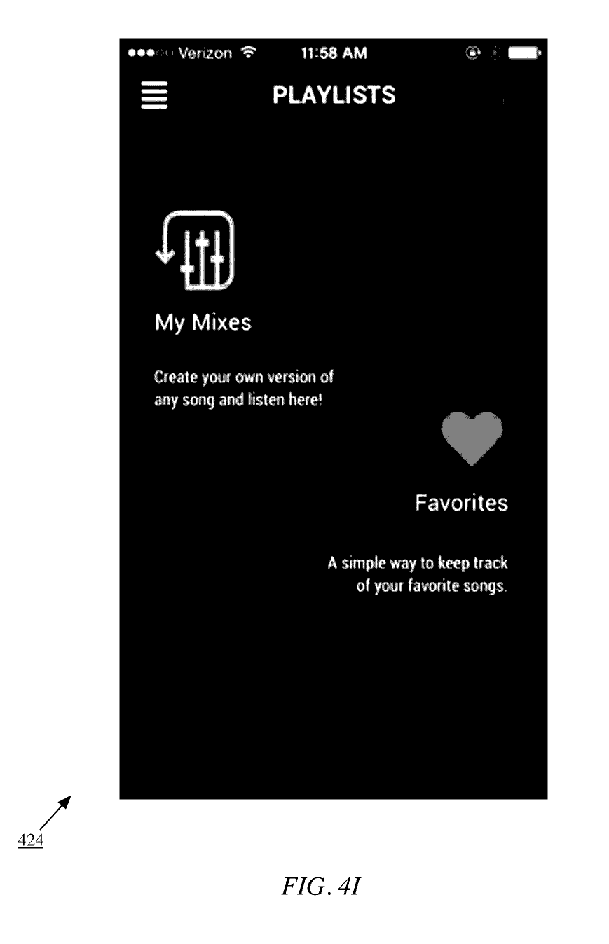

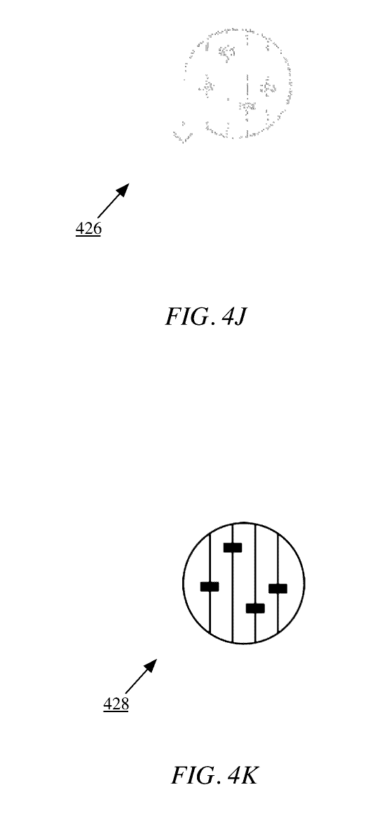

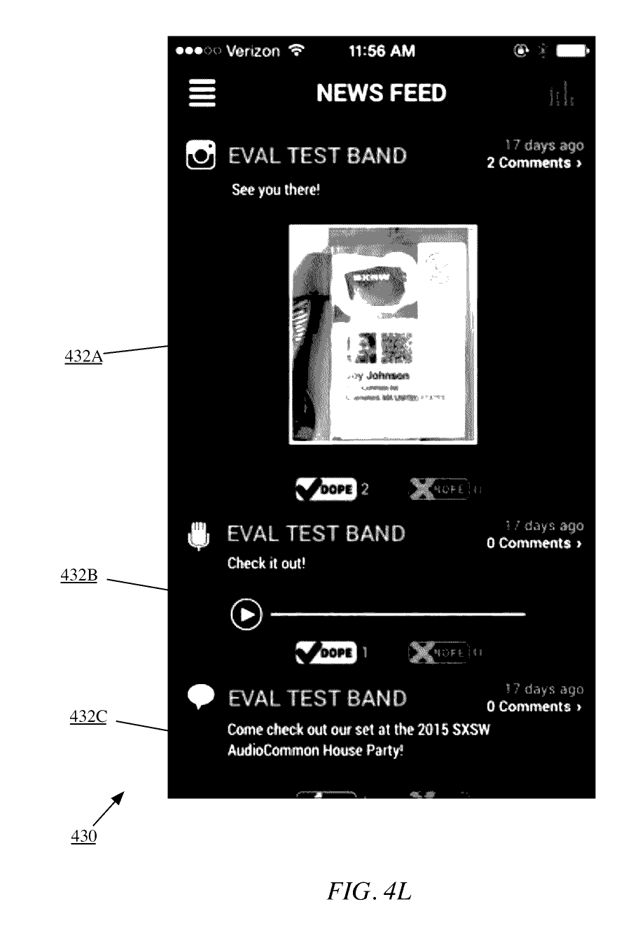

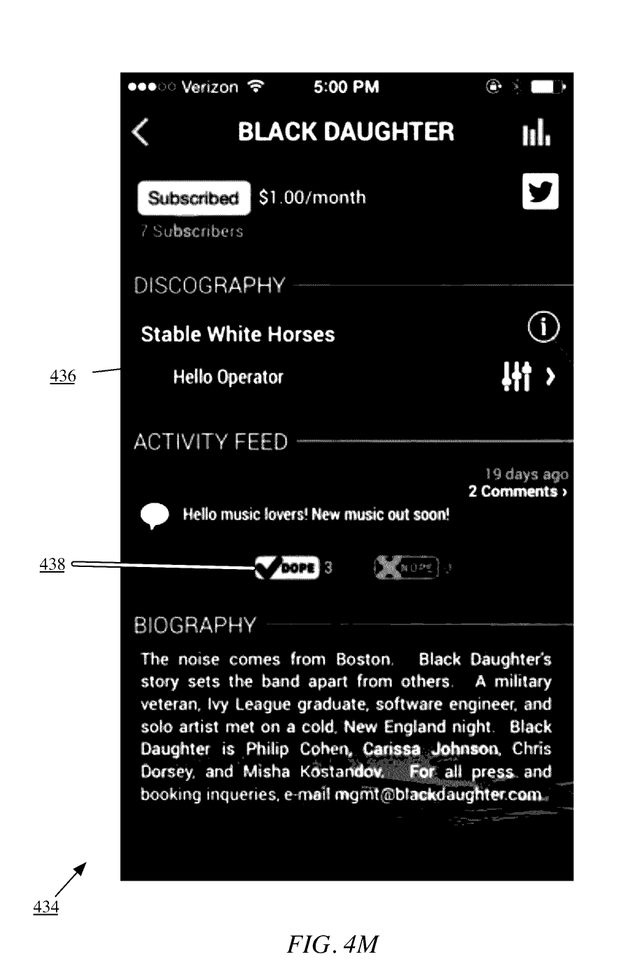

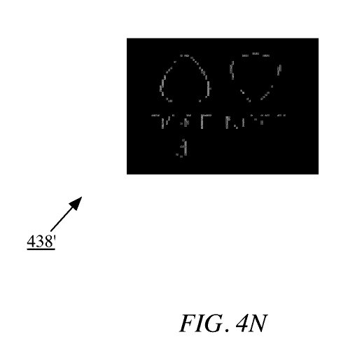

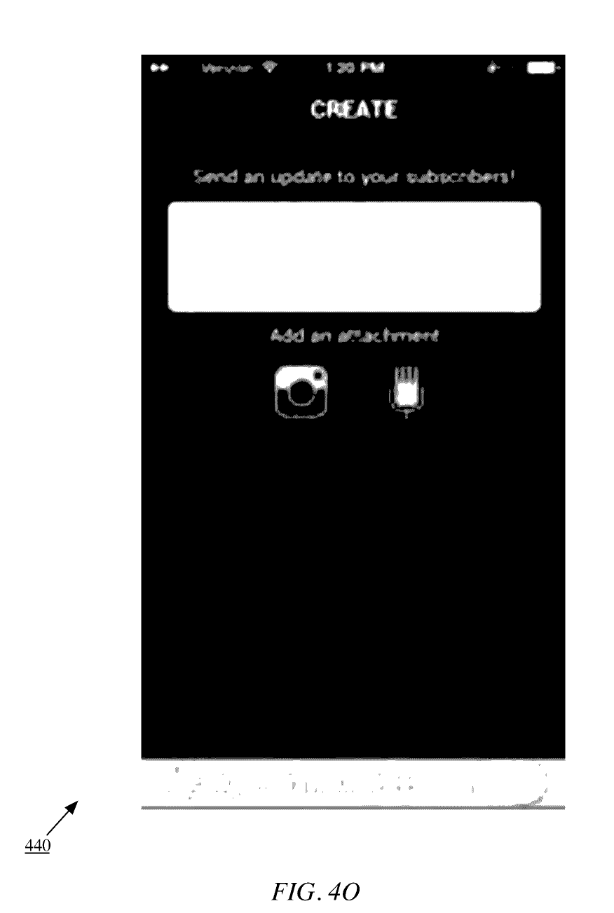

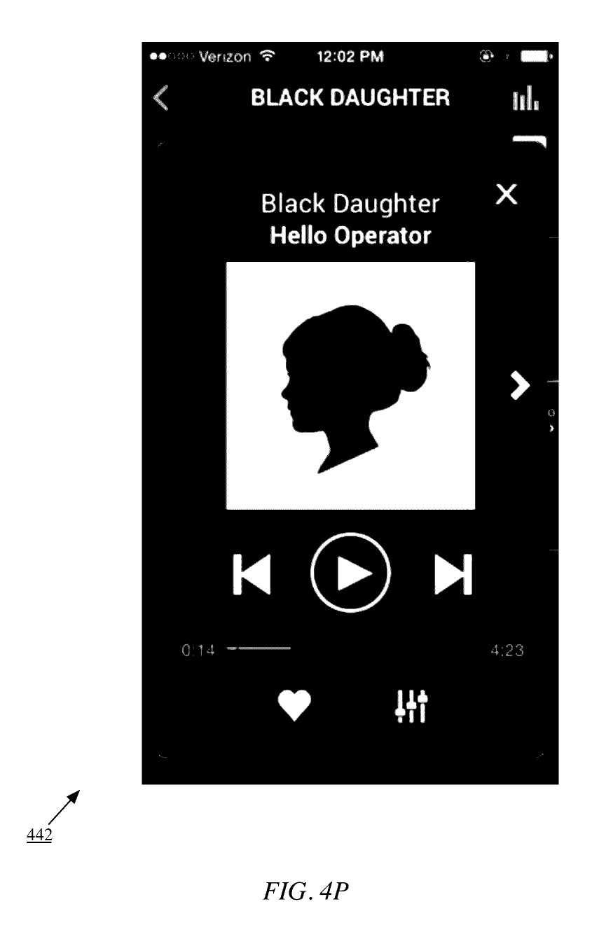

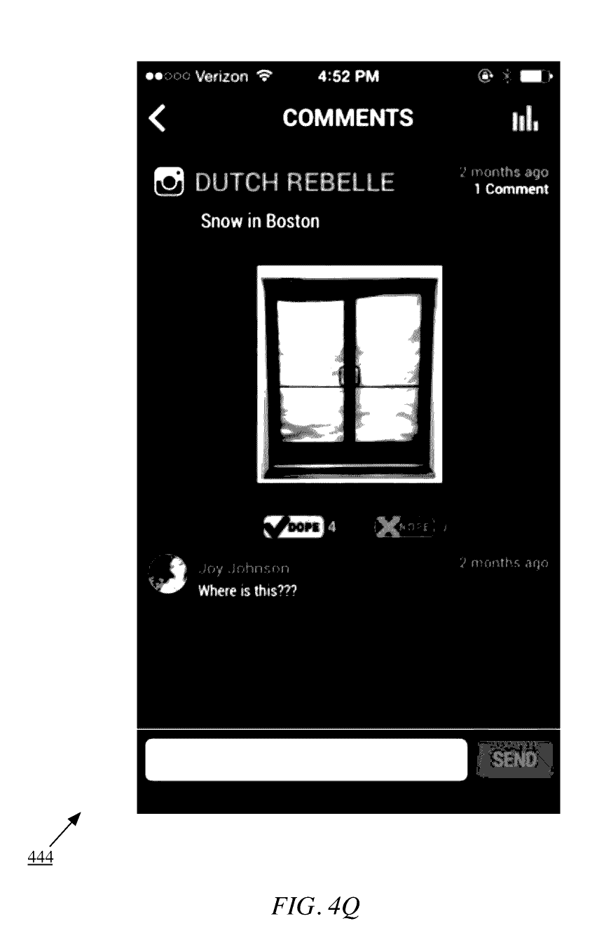

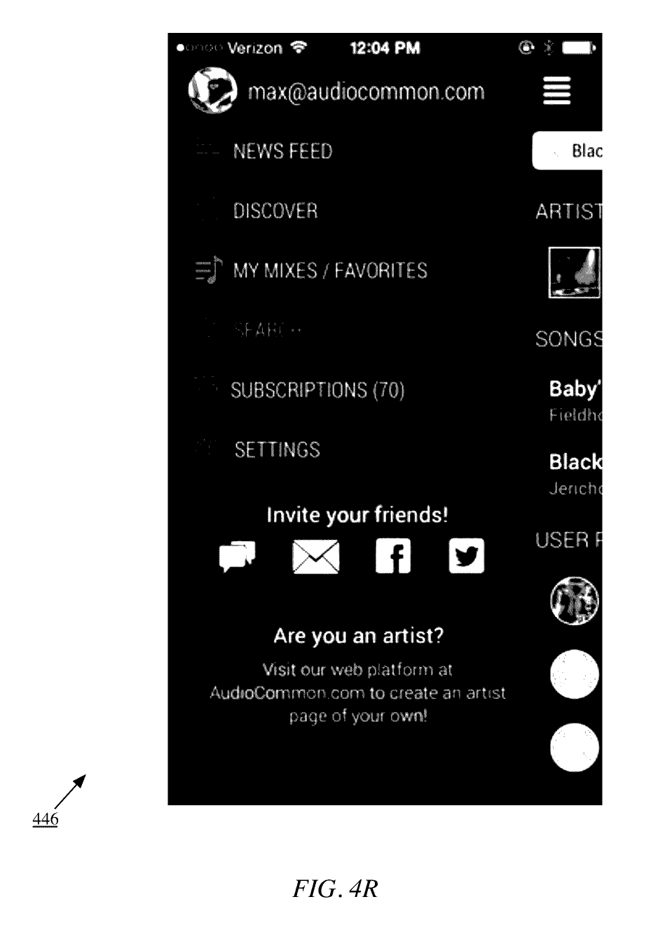

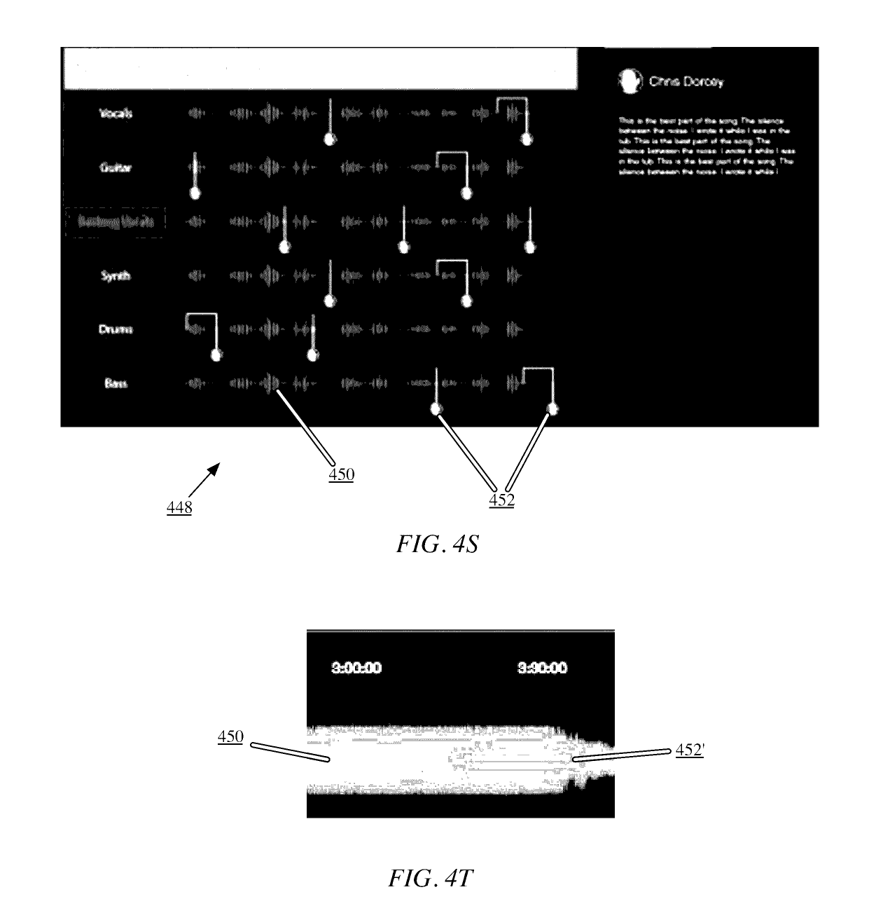

Application 102 may include a user interface 104. User interface 104 may be a graphical user interface for displaying information about playing media, including identifications of enabled or disabled tracks or other parameters, and for allowing a user to interact with or control parameters of the media. In some implementations, user interface 104 may provide other social networking features, such as the ability to comment on, share, or “like” media or artists, communicate with other users or artists, or perform other such functions. In some implementations, a user may subscribe to or follow an artist, gaining additional access to features associated with the artist, such as personalized messages, pre-release media or audio tracks, or other features. In some implementations, user interface 104 may be downloaded (and/or accessed from a local cache) and displayed by a browser application or plug-in, such as an Adobe Flash-based interface or an HTML5 interface. In other implementations, user interface 104 may be provided as part of an application, such as a standalone application for a tablet or smart phone. Screenshots of various implementations of user interfaces 104 are illustrated in FIGS. 4A-4T and discussed in more detail below.

Application 102 may instantiate a plurality of playback engines 108A-108N, referred to generally as playback engine(s) 108. A playback engine 108 may be a daemon, routine, service, plug-in, extension, or other executable logic for receiving, decoding, and playing media content. In some implementations, a playback engine 108 may include one or more decoders for encoded or compressed media, such as decoders of any of the various standards promulgated by the Motion Picture Experts Group (MPEG) or other industry groups, including MPEG Layer-3 Audio (MP3) or MPEG-4 (MP4), Advanced Audio Coding (AAC), Apple Lossless Encoding (ALE), Ogg Vorbis, H.264, Microsoft Windows Media Audio (WMA), Free Lossless Audio Coding (FLAC), or any other type and form of coding or compression. Application 102 may instantiate or execute a playback engine 108 for each track of multi-track media, such as a first playback engine for a vocal track, a second playback engine for a drum track, etc. In some implementations, application 102 may instantiate or execute an additional playback engine for a stereo or mono mixdown track, which may be provided separately. Although discussed primarily in terms of audio, in some implementations, media may include video or images. In such implementations, a playback engine 108 may decode images or video for rendering by application 102 and display to a user of client 100.

Playback engines 108 may adjust one or more parameters of media content during playback, responsive to user interactions via user interface 104. Parameters may include disabling or enabling (muting or de-muting) playback of a track (which may be explicitly performed in some implementations, or may be performed through adjusting a playback volume of the track to zero and restoring the volume to a prior setting in other implementations); panning or stereo positioning of tracks or placement within a surround field; playback volume; pitch; reverb; equalization; phasing or flanging; or any other such features.

Application 102 may include a mixer 106. Mixer 106 may be a routine, daemon, service, or other executable logic for combining outputs of a plurality of playback engines 108. In some implementations, mixer 106 may read from output buffers of each of a plurality of playback engines 108 in sequence as they decode audio, and may combine output data from each playback engine into a single stereo audio stream to provide to an output 110 of a client 100. Mixer 106 may perform a mixing algorithm to combine the outputs, while limiting the total combined amplitude of any sample to within a predetermined dynamic range. For example, in one such implementation, mixer 106 may average the outputs of two playback engines (e.g. (108A+108B)/2); in another implementation, mixer 106 may use a clipping adjustment (e.g. 108A+108B−108A*108B/2̂[bit depth]) to reduce amplitudes of signals that exceed the dynamic range, while not overly reducing a first signal responsive to a second signal being very quiet or silent. In still another implementation, normalization or amplitude adjustment may be applied to each output signal to reduce them by an amount necessary to ensure that, after mixing, the output is within the predetermined dynamic range, given a predetermined known maximum level. For example, two playback engine outputs may be summed and divided by a factor equal to the maximum absolute amplitude of the combination throughout the media content (e.g. if the largest combination of 108A+108B is 1.3 times the maximum dynamic range allowed, then the mixer may combine each set of samples as (108A+108B)/1.3). In yet still another implementation, dynamic range compression may be applied to samples the maximum dynamic range, to ensure that sufficient room remains for combining with other samples. In such implementations, soft signals or low samples may be unadjusted, while loud signals above a predetermined threshold may be reduced by a compression factor. The compression factor may be linear or logarithmic, in various implementations. In some implementations, a first pair of playback engine outputs may be combined, then the result combined with a next playback engine output, then further combined with a next playback engine output, etc., as necessary depending on the number of playback engines. In other implementations, three or more playback engine outputs may be simultaneously combined, using an extended averaging algorithm similar to those discussed above (e.g. 108A+108B+108C−108A*108B−108A*108C−108B*108C+108A*108B*108C, or any other such algorithm). In still other implementations, samples may be summed with a larger arithmetic bit depth (e.g. combining 16-bit samples in a 32-bit floating point operation), and normalized or limited if necessary to avoid exceeding the predetermined dynamic range. In other implementations, mixing functions may be performed by an audio engine of an operating system of client 100 or similar third-party library.

In some implementations, one or more tracks may be enabled or disabled by the user during playback. In one such implementation, mixer 106 may skip summing operations for disabled or muted playback engines. In another such implementation, the volume of a disabled track may be set to zero, and the mixer 106 may still perform summing operations for the playback engine with 0-level samples.

Playback engines 108 may be synchronized by application 102 by using a common clock or timer for outputting decoded samples to output buffers of the playback engines, in one implementation. For example, in one such implementation, playback engines 108 may be triggered to decode and output a sample by a commonly received trigger or pulse. In another implementation, playback engines 108 may be synchronized through an iterative operation in which each playback engine decodes and outputs one sample in turn and mixer 106 collects each sample for mixing, before repeating the process for the next sample. In still another implementation, output samples from each playback engine may be associated with a playback timestamp (e.g. presentation timestamp (PTS) or clock reference), and mixer 106 may collect and mix each sample having a common timestamp.

Mixed signals may be provided to an output 110, which may comprise an application programming interface (API) or other interface for providing output signals to a media interface of client 100 (e.g. an audio engine, audio interface, or other such interface). In some implementations, application 102 may communicate directly with audio hardware of the client 100, while in other implementations, output signals may be provided to an operating system or audio engine of the client.

In some implementations, a client 100 may include a network interface 112. Network interface 112 may be a wired network interface, such as an Ethernet interface, universal serial bus (USB) interface, or other such interface; or a wireless network interface, such as a cellular interface, an 802.11 (WiFi) interface, a wireless USB interface, a Bluetooth interface, or any other such interface. Client 100 may communicate via network interface 112 with a server 140 and/or data storage 148 via a network 130. In some implementations, client 100 may request and/or receive media via the network from server 140 or data storage 148, including individual audio tracks as discussed above, as well as images, video, text, or other data for presentation via user interface 104.

Client 100 may include a memory device 114. Memory 114 may be RAM, flash memory, a hard drive, an EPROM, or any other type and form of memory device or combination of memory devices. Although shown external to memory 114, in many implementations, application 102 may be stored within memory 114 and executed by a processor of client 100. Memory 114 may store a device identifier 116. Device identifier 116 may be a unique or semi-unique identifier of a device, such as a media access control (MAC) identifier, IP address, serial number, account name or user name, or any other type and form of identifying information. Device identifier 116 may be provided to a server 140 during login or authentication, or provided to server 140 during request for media.

Memory 114 may also include one or more media buffers 118, which may be used for storage of received media files, and/or input or output buffers for playback engines 108. For example, to ensure seamless playback during media streaming, an amount of media may be downloaded to client 100 prior to playback such that additional segments of media may be downloaded during playback before being required.

Network 130 may comprise a local area network (LAN), wide area network (WAN) such as the Internet, or a combination of one or more networks. Network 130 may include a cellular network, a satellite network, or one or more wired networks and/or wireless networks. Network 130 may include additional devices not illustrated, including gateways, firewalls, wireless access points, routers, switches, network address translators, or other devices.

Server 140 may be a desktop or rackmount server or other computing device, or a combination of one or more computing devices such as a server farm or cloud. In some implementations, server 140 may be one or more virtual machines executed by one or more physical machines, and may be expanded as necessary for scalability. Server 140 may include one or more network interfaces 112 and memory devices 114, similar to those in client 100.

Server 140 may include a processor executing a presentation engine 142. Presentation engine 142 may comprise an application, service, server, daemon, routine, or other executable logic for providing media to one or more client devices 100 for rendering by applications 102. In some implementations, presentation engine 142 may comprise a web server, a file server, a database server, and/or an application server. Presentation engine 142 may retrieve data, such as text, video, images, or audio, from local storage 146 or from remote data storage 148, and/or may transmit the data to clients 100.

Server 140 may store a relational database 144 for identification and association of media. Media, such as songs or videos, may be associated with multiple tracks, which may be stored in a single file or as separate files. Media may also be associated with artists, albums, producers, genres or styles, users or user groups, collaborations of artists, sessions, projects, or other associations. In some implementations, media may be organized in a hierarchy of folders, projects, and sessions. Folders may group related projects, which may have associated collaborators and management features. Sessions may organize related audio or media content and collaborators on individual items of media. Sessions may also be associated with individual tracks or mixes, or other media content.

Server 140 may maintain local data storage 146, which may comprise any type and form of memory storage device for storing media files and/or database 144. Media files may be encrypted, compressed, or both. In some implementations, server 140 may communicate with remote data storage 148, which may similarly maintain data storage 146′ for storing media files and/or database 144. Remote data storage 148 may comprise one or more computing devices including network attached storage (NAS) devices, storage area network (SAN) devices, storage server farms, cloud storage, or any other type and form of remotely accessible storage.

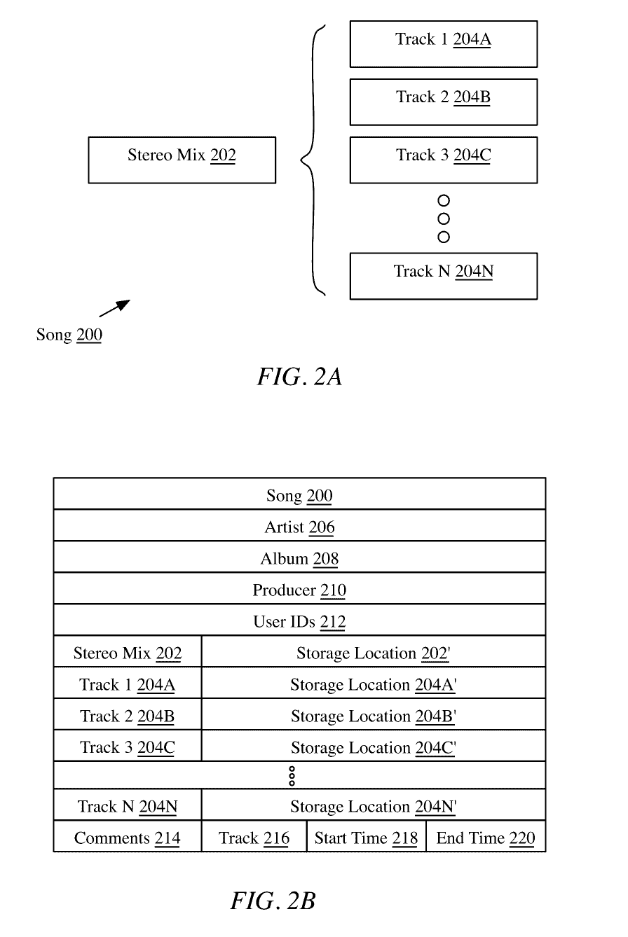

FIG. 2A is a diagram of a relationship between a stereo mix 202 and individual tracks 204A-204N of a song 200. Individual tracks 204A-204N, referred to generally as track(s) 204, may comprise individual audio files, such as MP3 files or uncompressed PCM audio, and may include one or more instruments of a song, typically associated with an individual performer. Tracks 204 may be stereo tracks or mono tracks, in various implementations. In some implementations, tracks 204 may all be the same length, and may contain one or more periods of silence. For example, a first track may be silent during an intro of a song while a second track includes audio. By maintaining the same length, playback of each track may be synchronized. Tracks 204 may be compressed such that periods of silence do not significantly add to the memory usage of the track. In some implementations, a track 204 may include several instruments mixed down to a single track. For example, a drum track may include kick drum, snare drum, hat, toms, cymbals, and/or other percussion instruments. Similarly, a sound effects track may include various sound effects or percussion instruments played intermittently throughout the song.

Stereo mix 202 may comprise a mix of all of the tracks 204A-204N, and may be used to provide immediate streaming playback. For example, a client device may download stereo mix 202, and begin playback of the stereo mix via a first playback engine. During playback, the client device may download tracks 204A-204N. Once the tracks 204 are downloaded, the client device may play the tracks via additional playback engines with the program timestamp or time counter from playback of the stereo mix, and simultaneously mute the playback engine playing the stereo mix. Accordingly, in such implementations, playback may seamlessly transition from the stereo mix to mixed individual tracks, and users may then interact with the individual tracks during playback. In many such implementations, stereo mix 202 and/or tracks 204A-204N may comprise a plurality of sub-files or “chunks”, such as 10-second clips, which may be downloaded and played to provide higher responsiveness, particularly for larger files. For example, a first 10-second clip may be downloaded, and playback initiated while a second subsequent 10-second clip is downloaded.

Depending on network speeds, in some implementations, a plurality of chunks or segments may be downloaded, such that additional segments may be downloaded before exhausting buffered data. For example, several segments of stereo mix 202 may be downloaded before beginning download of segments of tracks 204A-204N. In some implementations, the application may download segments of tracks 204A-204N starting at a midpoint of the files. For example, the application may download a first 20 seconds of the stereo mix, and then may begin downloading segments of tracks 204 beginning 20 seconds into the song. This may reduce bandwidth requirements.

In many implementations, as discussed above, tracks 204 and stereo mix 202 may be standard media files, such as MP3 files or WAV files. In other implementations, tracks 204, and optionally stereo mix 202, may be provided in a digital container format that enables packaging of multi-track data into a single file, such as a broadcast wave file (BWF) or stem file format (SFF). Such container files may contain both the stereo and mono mix-down of the file, as well as the individual audio files or tracks that make up the mix. Media files, including container formats or standard formats, can also contain other metadata related to the audio files, including but not limited to the recording hardware used (microphones, mixing boards, etc.), instruments used, effects used, date of recording, author, musician, commentary, other products/software used in the recording of the track, or any other data of interest. The metadata can include the appropriate mime-type of the metadata, so that an appropriate application or plugin can be used to render the metadata as intended. In some implementations, sequences of audio that are repeated (e.g., in loops) can be stored once in the file with time offset references of where they should exist in the final track. An audio player that understands loop metadata may re-create the audio tracks based on the data contained in the file. In some implementations, a container file may point to external resources instead of packaging the resources physically in the file, such as via uniform resource identifiers (URIs) or other addresses. During playback, the application may load or retrieve the external resources as necessary.

FIG. 2B is a diagram of an implementation of a multi-track song database. Although shown in tabular form, in some implementations, the database may be a relational database, a flat file, an array, or any other type and format of data structure. The database may include identifications of songs 200, and associated information including one or more artists 206, album 208, and producer 210. In some implementations, this information may be stored as data strings or text, unique IDs or user IDs, or other such data. In many implementations, a song 200 may be associated with multiple artists or collaborators 206, multiple albums 208 (e.g. an original album, a remix album, and a “best of” album), and multiple producers. The database may further associate the song with additional information including projects, folders, genres, styles, production and/or release year, or other such information. In some implementations, the database may include information about the song 200, such as the number of tracks 204 and/or length of the song.

The database may identify a stereo mix 202 and a URI or storage location 202′ for the stereo mix. Similarly, the database may identify one or more tracks 204 and corresponding storage locations or URIs 204′. As discussed above, in some implementations, the stereo mix and/or tracks may be encapsulated in a single container file format. In such implementations, the storage locations 204′ may identify an order of tracks within the container. In other implementations, the stereo mix and/or tracks may be stored as separate files and storage locations 204′ may identify remote storage locations, such as an URI of a resource on a streaming file server.

In some implementations, discussed in more detail below, a song may be associated with one or more comments 214. Comments may have a track association and, in some implementations, a start time 218 and end time 220. Comments may allow users and/or producers to comment on individual tracks as well as the entire stereo mix, in a way that is synchronized to the track timeline or applies to a temporal region.

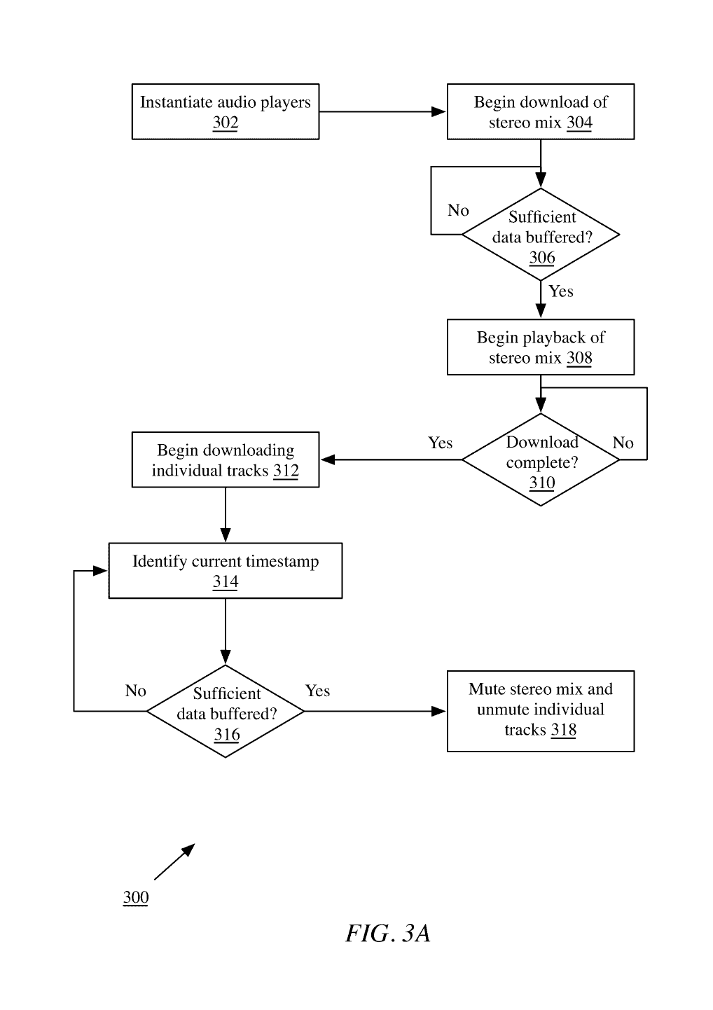

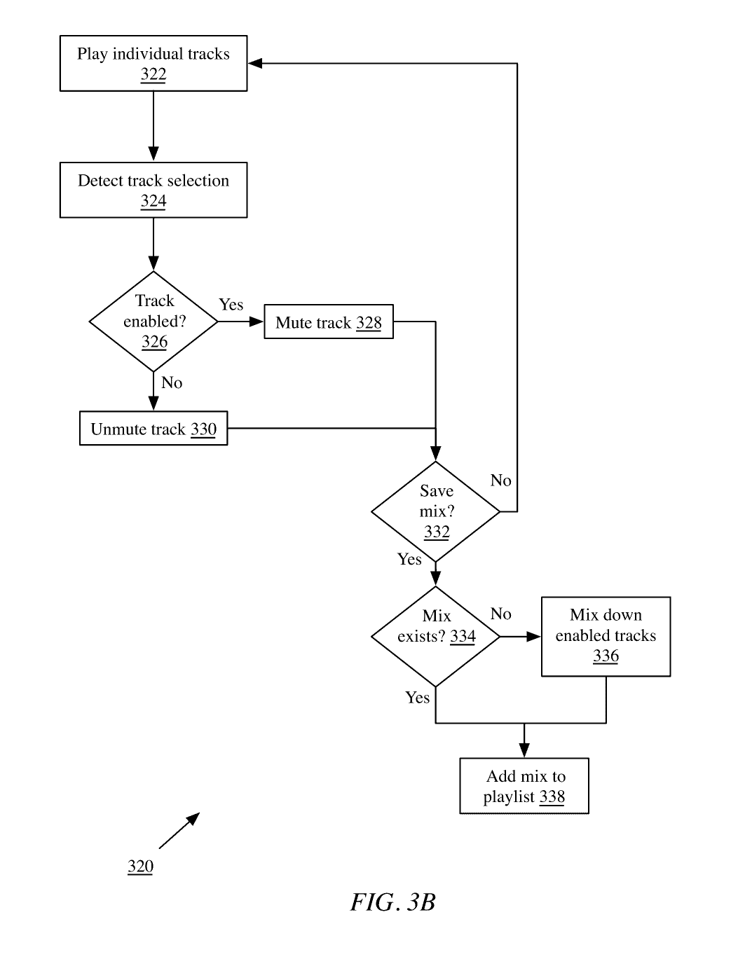

FIG. 3A is a flow chart of an implementation of a method 300 for providing streaming multi-track audio. Although discussed primarily in terms of audio, the same techniques may be applied to music videos with remixable audio tracks, television shows with separate voice, music, and sound effects tracks, or any other type and form of media for which additional user interaction may be desired. At step 302, a client device may instantiate a plurality of audio playback engines. Instantiating the playback engines may include launching or executing each playback engine in a separate execution thread, or launching an iterative process and configuring the process to perform a number of iterations equal to the number of tracks to be processed. In some implementations, instantiating the playback engines may comprise establishing input and output buffers for each playback engine in memory. The number of playback engines may be determined based on the number of tracks, plus the stereo mix in implementations in which a stereo mix is downloaded and played first. For example, given three tracks (e.g. vocals, guitar, and drums), four playback engines may be instantiated to process each track plus a stereo mix.

Step 302 may be performed responsive to a user selecting a song for playback, or selecting to view or edit multi-track stems or portions of a song. The client may transmit a request for the multi-track audio for the song, and may receive a response identifying the number of tracks and their locations (e.g. URIs) for download. In some implementations, the response may further identify each track (e.g. “Vocals”, “Backup vocals”, etc.) so that the client application may begin rendering the multi-track player while audio is being downloaded.

At step 304, in some implementations in which immediate streaming playback is desired, the client application may begin downloading the stereo mix or a portion (e.g. initial segments or chunks) of the stereo mix. This may continue until sufficient data has been buffered at step 306 that playback may commence without exhausting the amount of buffered data. The amount of data determined to be sufficient may be based on network conditions and average download speeds, and may be calculated such that the duration of buffered audio data exceeds the estimated time to download remaining data, including all individual tracks. For example, given a download speed of 1 MB/second and 5 tracks (a stereo mix, plus four individual tracks) of 10 MB each, it will take 50 seconds to download the tracks in their entirety. Once 50 seconds of the stereo mix have been downloaded (which may represent 1 to 2 MB of data), in one implementation, playback may commence. Safety factors may be applied to account for network latency or burstiness by extending the amount of data required before playback can begin, in some implementations. In other implementations, the application may download the entire stereo mix before proceeding to download individual tracks (e.g. at step 312). In such implementations, the amount of data determined to be sufficient may be based on the remaining data for just the stereo mix (e.g. 10 MB for just the stereo mix or 10 seconds of audio at 1 MB/second, using the numbers in the example discussed above, which may comprise a few hundred KB of data and be downloaded in less than a second). As discussed above, in some implementations, the application may download chunks of the individual tracks starting at a later time period within the audio (e.g. beginning at 50 seconds, or any other such time).

Once sufficient data has been buffered, the application may begin playback of the stereo mix at step 308. The application and/or mixer may maintain a timer or program reference clock for synchronizing all of the playback engines for seamless crossover to the individual tracks when downloaded. Playback of the stereo mix may include decoding compressed audio from the received chunks or file, and providing the decoded audio to an audio interface or audio engine of an operating system of the device.

While playback of the stereo mix proceeds, in some implementations, the application may continue to download the stereo mix at step 310 until it is complete, before proceeding to download the individual tracks at step 312. This ensures that the entire song is available quickly in case of network dropout or delay, rather than beginning downloading the individual tracks and potentially not having later audio segments available. In other implementations, as discussed above, the application may begin downloading the individual tracks at any earlier point, such as step 304 or step 308.

At step 314, in some implementations, the application may identify a current playback timestamp or program reference clock value from the playback of the stereo mix. At step 316, the application may determine if sufficient data from the individual tracks has been buffered. This may be done using any of the same methods discussed above in connection with step 306. A sufficient amount of data may be buffered when the application can download the remaining chunks or segments of the individual tracks, based on average network speeds and latency, before emptying the input buffers of the playback engines during decoding and playback. Steps 314-316 may be repeated until sufficient data from the individual tracks has been buffered.

At step 318, once sufficient data has been buffered to ensure that the playback engines will not exhaust the buffers, the application or a mixer of the application may mute or disable playback of the stereo mix, and unmute or enable playback of the individual tracks. The mixer may mix each track, using any of the mixing methods discussed above, and provide the mixed output to the audio interface of the client or an operating system of the client. In other implementations, step 316 may be skipped and the application may switch to playback of the individual tracks at step 318 as soon as data is available. If the network subsequently slows or fails to deliver further segments of the individual tracks, then the mixer may “fall back” to the stereo mix by unmuting playback of the stereo mix and muting the individual tracks.

Once individual tracks have been downloaded and are playing, the user may interact with the application to edit the mix. In one implementation, the user may be provided with toggle buttons to mute or unmute individual tracks, allowing the user to remove vocals, drums, or other tracks from a mix. This may be useful for karaoke purposes, to create instrumental remixes or for sampling for further creation, for learning parts of a song by playing along with the rest of the band, or any other such purpose. FIG. 3B is a flow chart of an implementation of a method 320 for providing dynamic editing during playback of multi-track audio. At step 322, the application may be playing individual tracks, as discussed above in connection with step 318 of FIG. 3A. At step 324, the application may detect an interaction with the user interface, such as a selection of a track to be enabled or disabled. In various implementations, the user interface may include toggle buttons, switches, volume controls, panning controls, equalizer dials, sliders, or other elements to allow the user to interact with a track. For example, in one such implementation, a first toggle may be associated with each track to enable or disable the track, while a second toggle may be associated with each track to apply reverb or bandpass filters. In the implementation illustrated in FIG. 3B, the user interface includes track selection toggles to disable/mute or enable/unmute individual tracks. In other implementations, similar steps may be performed to apply, remove, or adjust effects during playback.

At step 326, in the implementation illustrated, the application may determine if the selected track is presently enabled. If so, then at step 328, the track may be muted. If not, then at step 330, the track may be unmuted. In one implementation, tracks may be explicitly enabled or disabled, such that the mixer may not attempt to mix outputs from disabled playback engines with outputs of other playback engines. In another implementation, “disabling” a track may comprise setting a volume for the track to 0. In one implementation, the mixer or playback engine may multiply the decoded digital samples for the track by 0 (or replace the output samples with a predetermined middle value, for implementations using n-bit unsigned integer outputs where 0 amplitude equals 2̂(n−1), for example). The mixer may perform normal mixing operations as discussed above, combining the 0-amplitude samples of the track with other playback engine outputs. To re-enable the track, the mixer or playback engine may stop setting the output to zero. In some implementations in which track volumes may be adjusted, the mixer or playback engine may multiply samples by a volume coefficient (e.g. a value from 0 or less than 1 for reduction in volume, 1 for no volume change, or greater than 1 for increase in volume). When a track is disabled, the volume coefficient may be temporarily stored and replaced with a coefficient of 0. To re-enable the track, the 0 coefficient may be replaced with the stored value, restoring previous gain settings.

Although shown in terms of muting and unmuting tracks, as discussed above, in other implementations, similar methods may be used to control other parameters of a track, such as volume, panning, application of filters, reverb, or equalization, or any other such features or combination of features. In such implementations, at step 324, the application may detect an interaction with a user interface element, and at steps 326-330, the application may either apply or remove a modification. In some implementations, modifications may be pre-configured (e.g. bandpass filter settings, reverb parameters) and may be applied in similar toggle fashion to enabling or disabling a track. In other implementations, modifications may be adjusted by the user, either via another user interface screen or directly via the element (e.g. sliders, dials, etc.).

At step 332, the application may determine whether to save the adjusted mix. In some implementations, a user may explicitly select a “save mix” or “share mix” button or user interface element. Responsive to such a selection, the application may transmit a request to the server to generate a mix according to the selected parameters. For example, if a user disables two tracks of a five-track song, the server may generate a stereo mix with the remaining three tracks. The request may identify disabled tracks, may identify enabled tracks, may identify volume settings for one or more tracks, and/or may identify parameters for other adjustments for any track (e.g. pitch changes, filters, etc.). In some implementations, if a user selects to save a mix and then makes further adjustments, the application may transmit a new request to generate a mix. In other implementations, the application may wait until the song is complete to send the request, to ensure all modifications are captured. If the user does not select to save the mix or the application determines not to transmit the request at that time, then steps 322-332 may be repeated.

If the user elects to save the mix and/or the application transmits a request to generate a mix at step 332, then at step 334, the server may determine whether a corresponding mix has previously been generated. In one implementation, the server may record parameters of requests in a database in association with the media (e.g. tracks 3 and 4 disabled, track 5 set to 70% volume, reverb added to track 1, etc.) along with a storage location or URI of a generated mix corresponding to the requested parameters. If another user subsequently generates the same mix and request, the server may identify the previously generated mix, reducing processor and storage requirements.

If no previously generated mix exists corresponding to the request, then at step 336, the server may mix down the tracks according to the request parameters. The mixing may be performed in real-time, or in non-real time or “offline”, taking advantage of the scalability and potentially higher processing power of the server compared to the client device.

After generating the mix, or if a previously generated mix exists corresponding to the request, at step 338, the mix may be added to a playlist or saved set of mixes for the user. In some implementations, the social media platform may maintain playlists of songs, artists, albums, modified or customized mixes, shared songs or mixes, or other media in association with a device identifier or user identifier. The user may log in through the application, select a previously generated mix in the playlist (or other media in the playlist) and initiate streaming playback of the mix.

FIGS. 4A-4T are screenshots of implementations of a multi-track social media application. Although primarily shown with a smart phone interface and layout, similar implementations may be used for tablet computing devices, wearable computing devices, laptop or desktop computing devices, or other such devices. Referring first to FIG. 4A, illustrated is a screenshot of a discovery screen 400 for allowing users to discover new artists or content, and consume and modify or interact with content. The screen 400 may include a radial interface 402 with segments corresponding to each track of a multi-track item of media. Although the implementation illustrated is for a song, a similar interface may be used for music videos or slideshows set to music. Each segment of the radial interface 402 may be labeled according to its content, as shown. Each segment may be toggled by a user, such as via a touch interface, to enable or disable the corresponding track during playback. Once a user has enabled or disabled tracks or made other modifications, the user may select to save the mix using a saving interface 404. As discussed above, the application may transmit a request to a server to generate a corresponding stereo mix according to the selected parameters, or add a previously generated mix to the user's playlists.

In some implementations, the discovery screen 400 may include a subscribing and sharing interface 406 for subscribing to an artist or album, and/or for indicating that the artist, album, or song is a favorite or “liked”. The screen may also include artist and media identifiers 408, as well as an interface for retrieving and displaying additional information about the artist, album, or media. In some implementations, the discovery screen 400 may include tabs 410 for featured or spotlighted artists or albums, such as popular or trending albums or artists, newly published albums or artists, staff picks, etc. In one implementation, the discovery screen 400 may be “swiped” left or right to view other artists, albums, or multi-track media within the spotlighted or featured categories. Discovery screen 400 may also include a menu interface 412 for selecting other application features, such as viewing playlists, shared tracks, commenting, etc.

As discussed above, in some implementations, each segment of a radial interface 402 may be toggled by a user to enable or disable playback of the corresponding track. FIG. 4B is an illustration of one such segment in an enabled 402A and disabled state 402B. In one implementation, brightness may distinguish enabled and disabled tracks, while in another implementation, the segment may change color (e.g. green for enabled and red for disabled), or may be inverted (e.g. white text for enabled and black text for disabled). FIG. 4C is another illustration showing sets of 8 segments from all segments enabled 414A to all segments disabled 4141. In many implementations, songs may be limited to 8 tracks, with 8 corresponding segments as shown. If a song initially has more than 8 tracks, an artist or producer may be prompted to select tracks to combine or mix together before publishing the song or media via the social media application. In other implementations, songs may be limited to a smaller or larger number of tracks, such as 4 tracks, 6 tracks, 10 tracks, etc. Fewer or more segments may be added to the radial interface 402 accordingly. In some implementations, although tracks are limited to a maximum number of 8 tracks, some producers may not use all of the available tracks. For example, one song may only have an acoustic guitar and vocal track. In some such implementations, all but two of the tracks may be initially disabled (e.g. as shown in interface 414G). In a similar implementation, a third segment style may be used to indicate unused tracks, such as a darker color or unlabeled segment. In other implementations, the size or degree span of segments may be adjusted to cover a range of 360 degrees/# of tracks (with slight border gaps in some implementations, as shown). For example, given two tracks, each segment may be enlarged to approximately 180 degrees (minus gaps for clarity, such as 178 degrees with a 1 degree border on each end of the segment). Given four tracks, each segment may be adjusted to approximately 90 degrees (or potentially 88 degrees). This may provide larger interface elements for users, at the expense of a non-standard interface between songs.

FIG. 4D is a screenshot of another implementation of a discovery screen 400′. As shown, the radial interface 402 may include fewer than the total number of potential tracks, and a segment may be replaced by a gray or blank segment 402C. In some implementations, the radial interface may include animations 416 around each enabled segment. The animations may provide additional visual indicators of enabled tracks. In some implementations, the animations 416 may be static or unrelated to the content of the track and repeat frames at a constant rate. In other implementations, the animations 416 may be dynamic or related to the content of the track. In one such implementation, the animations 416 may repeat frames based on a beats-per-minute rate of the song. In another implementation, the animations 416 may have brightness or size based on an amplitude of the track. Radial interface 402 may also include a time indicator 418, such as a bar or line that extends around the interface at a rate corresponding to a temporal position within the song. In other implementations, other elements may be used, such as a clock hand.

FIG. 4E is an illustration of successive frames 416A-416C of an animation 416, according to one implementation. Although shown in one size and orientation for a first segment, animation 416 may be rotated to correspond to an Although shown in one size and orientation for a first segment, animation 416 may be rotated to correspond to any segment, and/or enlarged or shrunk to cover a larger or smaller range of the radial interface, as discussed above. The animation 416 illustrated in FIG. 4E may be referred to as a sonar or pulse animation, in some implementations.

FIG. 4F is an illustration of another implementation of a discovery screen including a bar animation element 416′. In one implementation, the bars may represent an average amplitude for a corresponding track. In a similar implementation, the bars may represent spectral content of the corresponding track. For example, a fast Fourier transform (FFT) may be used to convert a windowed audio signal in an amplitude vs. time domain into an amplitude vs. frequency domain. The frequency range may be divided into a predetermined number of bar regions, and a bar generated according to the average amplitude or power within the region (e.g. an integral of signals within a region bounded by an upper and lower frequencies). The length of each bar may accordingly represent energy or power within a frequency band, such as an octave, providing additional information to the user. In another implementation, to reduce processing requirements, each bar length at any timestamp may be precalculated and provided as metadata to each track. In still another implementation, bars may be pre-rendered and animated and/or may not correspond to content of the track. The bars may instead be pulsed or set to heights randomly or based on a beats-per-minute rate of the song. For example, FIG. 4G is an illustration of one such pre-rendered bar 416′ that may be rotated and/or stretched into position around enabled tracks.

FIG. 4H is a screenshot of an implementation of a multi-track control room interface 420. The implementation shown may provide greater detail of multi-track content, at the risk of additional complexity. As shown, each track may be displayed with a corresponding waveform. Indicators 422A-422B may be displayed next to each track to indicate whether the track is enabled or disabled. In one implementation, the indicators may also be input elements, and the user may press or interact with the indicator to change a corresponding track from an enabled state to a disabled state or vice versa.

FIG. 4I is a screenshot of an implementation of a playlist selection screen 424. The playlist select screen may be divided into “My Mixes” which may comprise user-customized or modified multi-track content that has been saved and down mixed by the server, as discussed above in connection with FIG. 3B; and “Favorites” which may comprise user-selected or “liked” content. FIG. 4J is a screenshot of an implementation of an icon 426 for accessing customized or modified multi-track content. FIG. 4K is a screenshot of an implementation of a second icon 428 for accessing original multi-track content (e.g. accessing a control room screen 420 as discussed above in connection with FIG. 4H, or manually loading multi-track content rather than a stereo mix).

FIG. 4L is a screenshot of an implementation of a news feed screen 430. The news feed screen may show one or more news segments 432A-432C, and may be scrolled up and down by the user to see additional (older or newer) news items. As shown, news items may include text, photos, audio (such as songs, voice recordings or messages, or other such content), links to websites or other such information. Users may select a comment screen to read or provide comments on news segments, and may also select to like or dislike a news item via a “dope” or “nope” interface.

FIG. 4M is a screenshot of an artist information screen 434. The artist information screen may include information about the artist, such as a biography and discography, with options to download and interact with multi-track versions of songs 436. The artist information screen may include an activity feed, which may be an artist-specific news feed similar to that shown in FIG. 4L, and may include similar “dope” or “nope” interface elements 438. In some implementations, a user may subscribe to an artist, either for free or for set rates, such as a set amount per month. Subscribing to the user may allow access to features not available to non-subscribing members. For example, in one such implementation, non-subscribing members may be able to listen to stereo mixes of songs, but may not be able to view or interact with individual tracks via the control room or radial interfaces; such features may be reserved for subscribers. FIG. 4N is a screenshot of another implementation of a “dope” or “nope” interface using a guitar pick motif.

FIG. 4O is a screenshot of a comment or news item creation screen 440, according to one implementation. As shown, artists, producers, or other users of the system may enter text updates to add to an activity or news feed or as a comment on a song, album, news item, or other content. Users may also add attachments via a camera or microphone of the computing device, by taking a picture or recording a short message.

FIG. 4P is a screenshot of an implementation of a playback screen 442 without a multi-track interface. In some implementations, users who have not subscribed to an artist may only be able to consume pre-mixed content or may not view or interact with multi-track stems. In other implementations, playback screen 442 may be used when a user has selected a previously generated custom or modified mixes from a playlist. In some implementations, as shown, a multitrack icon may be provided to allow the user to switch to a multi-track control room or radial interface screen.

As discussed above, users may leave comments on news items, songs, or other content. FIG. 4Q is a screen shot of one such implementation of a comment screen 444. As shown, users may view an item such as a picture or text, and may read comments from and leave comments to other users or artists.

FIG. 4R is a screenshot of an implementation of a sidebar menu 446 for a mobile application. In one implementation, the sidebar menu may slide out from a side of the screen when a user interacts with a menu button or interface element. The user may select various items in the menu to load different screens of the application, such as a news feed, discovery screen, playlists, search menu, subscription list, profile settings, or other features.

In some implementations, comments may be identified with start times and/or end times and correspond to temporal positions or regions within a track of a multi-track session, referred to respectively as point comments or region comments. FIGS. 4S and 4T are screenshots illustrating various implementations of time-synchronized commenting such as in a multi-track control room screen 448. A marker 452, 452′ associated with each comment identifies the position or region of time on the track waveform 450. In some implementations, the marker may stretch across the region from a start to finish position, as shown in FIG. 4T. In other implementations, the marker may extend over or under the track bracketing the identified region, as shown in some of the markers in FIG. 4S. The width of the marker matches the specific length of time that is represented by the region marker, or may be a single point of minimal width if the comment pertains to a specific instance of time. Point/region comments may created by a user selecting or clicking within a track's waveform 450. During playback, as each comment is reached, they may be displayed in a portion of the screen, as shown in FIG. 4S. To determine the start time of the comment (or annotation), the system calculates the relative position of the user click with respect to the audio track. If the user performs a click-and-drag action, the end time of the comment is also calculated based on the point at which the mouse or touch is released. The user is then prompted to enter the comment, after which or during which the user can either save or cancel the input operation. If a comment is saved, the content of the comment, the associated track, the start and end time, and information about the user who made the comment are saved to a database. In some implementations, the user may adjust the position of the marker and/or its start or end point by selecting and dragging the marker or marker end. In some situations, multiple range comments on the same waveform may overlap in time. The markers of these comments can be stacked without directly overlapping visually, such that the vertical positions of the markers are different. Each comment can also be added to a comment list for a session, so that users can easily view all the comments for a particular session, e.g., a song.

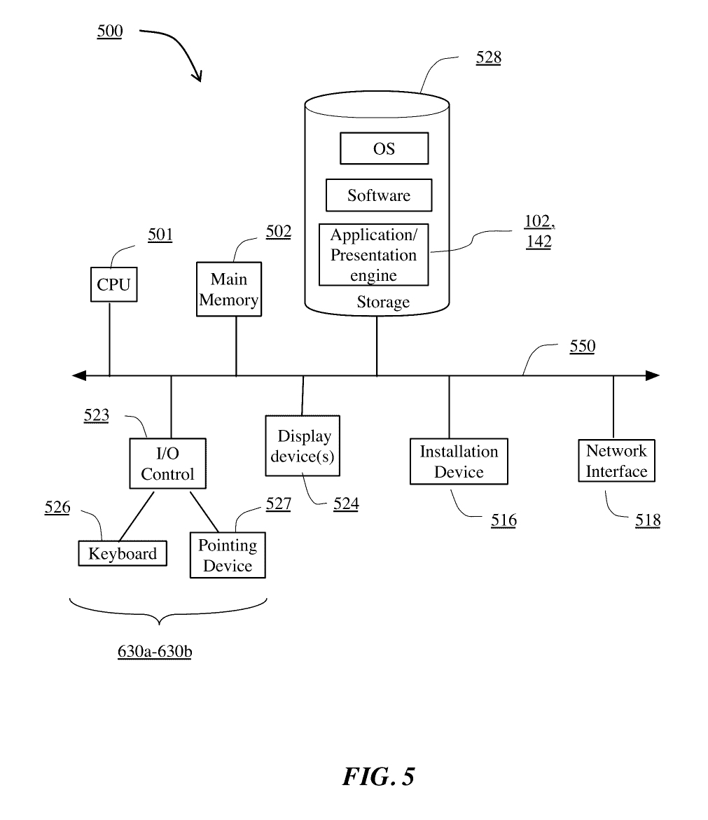

FIG. 5 is a block diagram of an exemplary computing device useful for practicing the methods and systems described herein. The various devices and servers may be deployed as and/or executed on any type and form of computing device, such as a computer, network device or appliance capable of communicating on any type and form of network and performing the operations described herein. The computing device may comprise a laptop computer, desktop computer, virtual machine executed by a physical computer, tablet computer, such as an iPad tablet manufactured by Apple Inc. or Android-based tablet such as those manufactured by Samsung, Inc. or Motorola, Inc., smart phone or PDA such as an iPhone-brand/iOS-based smart phone manufactured by Apple Inc., Android-based smart phone such as a Samsung Galaxy or HTC Droid smart phone, or any other type and form of computing device. FIG. 5 depicts a block diagram of a computing device 500 useful for practicing an embodiment of the appliance 100, server 140, management server 150, or management device 160. A computing device 500 may include a central processing unit 501; a main memory unit 502; a visual display device 524; one or more input/output devices 530a-530b (generally referred to using reference numeral 530), such as a keyboard 526, which may be a virtual keyboard or a physical keyboard, and/or a pointing device 527, such as a mouse, touchpad, or capacitive or resistive single- or multi-touch input device; and a cache memory 540 in communication with the central processing unit 501.

The central processing unit 501 is any logic circuitry that responds to and processes instructions fetched from the main memory unit 502 and/or storage 528. The central processing unit may be provided by a microprocessor unit, such as: those manufactured by Intel Corporation of Santa Clara, Calif.; those manufactured by Motorola Corporation of Schaumburg, Ill.; those manufactured by Apple Inc. of Cupertino Calif., or any other single- or multi-core processor, or any other processor capable of operating as described herein, or a combination of two or more single- or multi-core processors. Main memory unit 502 may be one or more memory chips capable of storing data and allowing any storage location to be directly accessed by the microprocessor 501, such as random access memory (RAM) of any type. In some embodiments, main memory unit 502 may include cache memory or other types of memory.

The computing device 500 may support any suitable installation device 516, such as a floppy disk drive, a CD-ROM drive, a CD-R/RW drive, a DVD-ROM drive, tape drives of various formats, USB/Flash devices, a hard-drive or any other device suitable for installing software and programs such as a social media application or presentation engine, or portion thereof. The computing device 500 may further comprise a storage device 528, such as one or more hard disk drives or redundant arrays of independent disks, for storing an operating system and other related software, and for storing application software programs such as any program related to the social media application or presentation engine.

Furthermore, the computing device 500 may include a network interface 518 to interface to a Local Area Network (LAN), Wide Area Network (WAN) or the Internet through a variety of connections including, but not limited to, standard telephone lines, LAN or WAN links (e.g., Ethernet, T1, T3, 56 kb, X.25), broadband connections (e.g., ISDN, Frame Relay, ATM), wireless connections, (802.11a/b/g/n/ac, BlueTooth), cellular connections, or some combination of any or all of the above. The network interface 518 may comprise a built-in network adapter, network interface card, PCMCIA network card, card bus network adapter, wireless network adapter, USB network adapter, cellular modem or any other device suitable for interfacing the computing device 500 to any type of network capable of communication and performing the operations described herein.

A wide variety of I/O devices 530a-530n may be present in the computing device 500. Input devices include keyboards, mice, trackpads, trackballs, microphones, drawing tablets, and single- or multi-touch screens. Output devices include video displays, speakers, headphones, inkjet printers, laser printers, and dye-sublimation printers. The I/O devices 530 may be controlled by an I/O controller 523 as shown in FIG. 5. The I/O controller may control one or more I/O devices such as a keyboard 526 and a pointing device 527, e.g., a mouse, optical pen, or multi-touch screen. Furthermore, an I/O device may also provide storage 528 and/or an installation medium 516 for the computing device 500. The computing device 500 may provide USB connections to receive handheld USB storage devices such as the USB Flash Drive line of devices manufactured by Twintech Industry, Inc. of Los Alamitos, Calif.

The computing device 500 may comprise or be connected to multiple display devices 524a-524n, which each may be of the same or different type and/or form. As such, any of the I/O devices 530a-530n and/or the I/O controller 523 may comprise any type and/or form of suitable hardware, software embodied on a tangible medium, or combination of hardware and software to support, enable or provide for the connection and use of multiple display devices 524a-524n by the computing device 500. For example, the computing device 500 may include any type and/or form of video adapter, video card, driver, and/or library to interface, communicate, connect or otherwise use the display devices 524a-524n. A video adapter may comprise multiple connectors to interface to multiple display devices 524a-524n. The computing device 500 may include multiple video adapters, with each video adapter connected to one or more of the display devices 524a-524n. Any portion of the operating system of the computing device 500 may be configured for using multiple displays 524a-524n. Additionally, one or more of the display devices 524a-524n may be provided by one or more other computing devices, such as computing devices 500a and 500b connected to the computing device 500, for example, via a network. These embodiments may include any type of software embodied on a tangible medium designed and constructed to use another computer's display device as a second display device 524a for the computing device 500. One ordinarily skilled in the art will recognize and appreciate the various ways and embodiments that a computing device 500 may be configured to have multiple display devices 524a-524n.

A computing device 500 of the sort depicted in FIG. 5 typically operates under the control of an operating system, such as any of the versions of the Microsoft® Windows operating systems, the different releases of the Unix and Linux operating systems, any version of the Mac OS® for Macintosh computers, any embedded operating system, any real-time operating system, any open source operating system, any proprietary operating system, any operating systems for mobile computing devices, or any other operating system capable of running on the computing device and performing the operations described herein.

The computing device 500 may have different processors, operating systems, and input devices consistent with the device. For example, in one embodiment, the computer 500 is an Apple iPhone or Motorola Droid smart phone, or an Apple iPad or Samsung Galaxy Tab tablet computer, incorporating multi-input touch screens. Moreover, the computing device 500 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software embodied on a tangible medium, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

What is claimed:

1. A method for multi-track media playback comprising:
transmitting, by a client device to a server, a request for an item of media;
receiving, by the client device from the server, an identification of locations of each of a plurality of tracks of the item of media;
instantiating, by the client device, a plurality of playback engines corresponding to the plurality of tracks;
retrieving, by the client device, a first portion of each of the plurality of tracks of the item of media based on the received identifications;
directing, by the client device, each of the retrieved first portions of each of the plurality of tracks to a corresponding one of the plurality of playback engines;
decoding, by each playback engine, the first portion of the corresponding track of the plurality of tracks; and
iteratively combining, by a mixer of the client device, outputs of each of the plurality of playback engines to generate a combined multi-track output.

2. The method of claim 1, further comprising:
retrieving a second portion of each of the plurality of tracks of the item of media, during decoding of the first portion of the plurality of tracks by the plurality of playback engines.

3. The method of claim 1, wherein instantiating the plurality of playback engines further comprises establishing separate input and output buffers for each of the plurality of playback engines.

4. The method of claim 1, wherein each of the plurality of tracks comprise a separate stereo audio file.

5. The method of claim 1, wherein iteratively combining outputs of each of the plurality of playback engines further comprises:
combining outputs of a first and second playback engine of the plurality of playback engines to create a first intermediate output; and
combining the first intermediate output and the output of a third playback engine to create a second intermediate output.

6. The method of claim 1, wherein the identification of locations of each of the plurality of tracks further comprises an identification of a location of a pre-generated mix of the plurality of tracks; and further comprising:
instantiating an additional playback engine;
retrieving, by the client device, a first portion of the pre-generated mix;
directing, by the client device, the retrieved first portion of the pre-generated mix to the additional playback engine; and
decoding, by the additional playback engine while retrieving the first portions of each of the plurality of tracks, the first portion of the pre-generated mix.

7. The method of claim 6, further comprising synchronizing decoding of the plurality of playback engines and the additional playback engine according to a program clock triggered by the additional playback engine during decoding the first portion of the pre-generated mix.

8. The method of claim 7, further comprising disabling output of the additional playback engine and enabling output of each of the plurality of playback engines, responsive to decoding the first portions of the plurality of tracks.

9. A method for dynamically editable multi-track playback by a mobile device, comprising:
decoding a plurality of tracks of a multi-track item of media, by a corresponding plurality of playback engines executed by a processor of a mobile device;
iteratively combining, by a mixer of the mobile device, outputs of each of the plurality of playback engines to generate a combined multi-track output;
detecting, by the processor, a user interaction with an interface element corresponding to a first track of the plurality of tracks;
modifying, by the mixer, the output of a first playback engine corresponding to the first track, responsive to the detected user interaction; and
iteratively combining, by the mixer, the modified output of the first playback engine with outputs of each of the other playback engines to generate a second combined multi-track output.

10. The method of claim 9, wherein detecting the user interaction comprises detecting an interaction with a toggle identifying an enable state of the first track.

11. The method of claim 9, wherein modifying the output of the first playback engine comprises multiplying the output of the first playback engine by a volume coefficient.

12. The method of claim 11, wherein detecting the user interaction comprises detecting a disable track command for the first track; and wherein the volume coefficient is equal to zero.

13. The method of claim 11, wherein detecting the user interaction comprises detecting an enable track command for the first track; and wherein the volume coefficient is equal to a predetermined value.

14. The method of claim 13, further comprising setting the predetermined value, by the mixer, according to a volume coefficient value prior to receipt of a disable track command for the first track.

15. The method of claim 9, further comprising receiving the plurality of tracks from a second device.

16. The method of claim 15, further comprising transmitting a request, by the mobile device to the second device, to generate a single file comprising the second combined multi-track output.

17. A method for sharing dynamically modified multi-track media, comprising:
receiving, by a server from a first device, a request for a multi-track item of media;
transmitting, by the server to the first device, an identification of locations of each of the plurality of tracks of the item of media, responsive to the request;
receiving, by the server from the first device, a request to generate a single file comprising a modified combination of the plurality of tracks, the request comprising modification parameters for each track;
retrieving, by the server, the plurality of tracks of the item of media from the identified locations;
iteratively combining each of the plurality of tracks to generate a new version of the item of media, by the server, each track modified according to the modification parameters; and
associating the first device with the new version of the item of media.

18. The method of claim 17, further comprising:
receiving, by the server from a second device, a second request to generate the single file comprising the modified combination of the plurality of tracks;
determining, by the server, that modification parameters of the second request are identical to those of the first request; and
associating the second device with the new version of the item of media, responsive to the determination.

19. The method of claim 18, further comprising transmitting the new version of the item of media generated for the first device, to the second device, responsive to receipt of the second request.

20. The method of claim 17, further comprising receiving a request, by the server from the first device, to share the new version of the item of media with a second device; and
associating the second device with the new version of the item of media, responsive to receipt of the request to share the new version of the item of media.
